(19) United States
(12) Patent Application Publication
(10) Pub. No.: US 2024/0262239 A1
(43) Pub. Date: Aug. 8, 2024

(54) METHOD AND APPARATUS FOR PROVIDING CONGESTION PREDICTION INFORMATION FOR REFUELING STATION

(71) Applicant: HL Mando Corporation, Pyeongtaek-si (KR)

(72) Inventors: Eunjung NO, Seongnam-si (KR); Bumrae CHO, Seoul (KR); Yeonjoon HAN, Seoul (KR)

(73) Assignee: HL Mando Corporation, Pyeongtaek-si (KR)

(21) Appl. No.: 18/204,531

(22) Filed: Jun. 1, 2023

(30) Foreign Application Priority Data
Feb. 7, 2023 (KR) 10-2023-0015962
May 26, 2023 (KR) 10-2023-0068078

(51) Int. Cl. B60L 53/68; B60L 53/63

(52) U.S. Cl. CPC B60L 53/68; B60L 53/63

(57) ABSTRACT

According to one embodiment of the present disclosure, a method for providing information on a hydrogen refueling station by a user terminal may comprise requesting information on the hydrogen refueling station from a congestion prediction apparatus, receiving congestion prediction information for the hydrogen refueling station after the current time from the congestion prediction apparatus, and providing the congestion prediction information to a user, wherein the congestion prediction information is generated by a congestion prediction model trained based on variable data collected in advance, and the variable data include environmental information on hydrogen refueling stations, information on the date when the environmental information was collected, and weather information of the corresponding date.

### TECHNICAL FIELD

The present disclosure relates to a method and apparatus for providing congestion prediction information for a refueling station. More specifically, the present disclosure relates to a method and apparatus for predicting congestion of a refueling station for vehicles based on machine learning and/or deep learning, and providing a user with congestion prediction information for the corresponding refueling station.

### BACKGROUND

To operate a vehicle, periodic refueling is necessary. Vehicles commonly use oil, gas, and electricity for their fuel: recently, however, the number of vehicles that use hydrogen as a primary fuel (hydrogen vehicles) is steadily increasing.

Among the fuels used for vehicles, hydrogen is refueled based on the pressure difference between a hydrogen tank of a hydrogen refueling station and a hydrogen tank of a hydrogen-powered vehicle. Since the pressure of a hydrogen tank in a hydrogen refueling station is lowered after the hydrogen tank of a hydrogen-powered vehicle is filled up, additional time is required to re-compress the hydrogen. Therefore, although it only takes about 5 minutes to refuel a hydrogen vehicle, the entire refueling process may take up to 30 minutes, depending on the condition of the hydrogen tank at the hydrogen refueling station. Due to the above characteristics of hydrogen energy, a hydrogen vehicle user may have to wait a long time, which leads to increased congestion in a hydrogen refueling station.

Therefore, there is a need for a method for reducing congestion at a refueling station by reducing the waiting time of a vehicle user at the refueling station for refueling.

### SUMMARY

An object of the present disclosure is to provide a method and apparatus for reducing waiting time of a vehicle user for refueling at a refueling station.

Another object of the present disclosure is to provide a method and apparatus for providing not only real-time congestion information of refueling stations but also congestion prediction information for the future.

Yet another object of the present disclosure is to provide a method and apparatus for lowering congestion in a refueling station.

Technical objects to be achieved by the present disclosure are not limited to those described above, and other technical objects not mentioned above may also be clearly understood from the descriptions given below by those skilled in the art to which the present disclosure belongs.

According to one embodiment of the present disclosure, an apparatus for providing information on a hydrogen refueling station may comprise a transceiver configured to receive congestion prediction information on the hydrogen refueling station after the current time from a congestion prediction apparatus, a processor configured to generate information related to the hydrogen refueling station, and a display configured to display information related to the hydrogen refueling station, wherein the congestion prediction information is generated by a congestion prediction model trained based on variable data collected in advance, and the variable data include environmental information on hydrogen refueling stations, information on the date when the environmental information was collected, and weather information of the corresponding date.

Here, the congestion prediction information may include information on the number of waiting vehicles at the hydrogen refueling station predicted for each unit time.

Also, the environmental information may include at least one of an identifier of each hydrogen refueling station, the number of waiting vehicles in each hydrogen refueling station, the accumulated number of hydrogen vehicles, the accumulated number of hydrogen refueling stations, density of vehicles visiting each hydrogen refueling station per region, and inference time of the congestion prediction model, wherein the date information includes information on at least one of date, time, day of the week, weekend, and holiday, and the weather information includes information on at least one of temperature, humidity, precipitation, and precipitation type.

Also, the variable data may further include information generated by arithmetic operations on the information randomly selected from among the variable data.

Also, the variable data is pre-processed before being input to the congestion prediction model, and the pre-processing may include a process of removing outliers from the variable data based on at least one of the interquartile range for the variable data and the number of waiting vehicles identified by an imaging device installed at each hydrogen refueling station, a process of adding missing values to the variable data from which the outliers have been removed based on Multiple Imputation by Chained Equation (MICE), and a process of normalizing the variable data to which the missing values are added based on MinMaxScaler.

Also, the processor may calculate an average refueling interval of the user based on the user's refueling history information and predict an expected refueling date of the user based on the average refueling interval.

Also, the processor may select at least one of hydrogen refueling stations in the surroundings of the user from the user's location information and requests information on the selected hydrogen refueling station from the congestion prediction apparatus, wherein the information on the selected hydrogen refueling station may include congestion prediction information and refueling price information for the corresponding hydrogen refueling station after the expected refueling date.

According to another embodiment of the present disclosure, a method for providing information on a hydrogen refueling station by a user terminal may include requesting information on the hydrogen refueling station from a congestion prediction apparatus, receiving congestion prediction information for the hydrogen refueling station after the current time from the congestion prediction apparatus, and providing the congestion prediction information to a user, wherein the congestion prediction information is generated by a congestion prediction model trained based on variable data collected in advance, and the variable data include environmental information on hydrogen refueling stations, information on the date when the environmental information was collected, and weather information of the corresponding date.

According to yet another embodiment of the present disclosure, an apparatus for predicting congestion of a hydrogen refueling station may comprise a processor configured to generate congestion prediction information for the hydrogen refueling station after the current time using a congestion prediction model trained based on variable data collected in advance and a communication interface configured to provide a user terminal with the congestion prediction information for the hydrogen refueling station based on the user terminal's request for information on the hydrogen refueling station, wherein the variable data include environmental information on hydrogen refueling stations, information on the date when the environmental information was collected, and weather information of the corresponding date.

According to still another embodiment of the present disclosure, a method for providing congestion prediction information for a hydrogen refueling station by a congestion prediction apparatus may include generating congestion prediction information for the hydrogen refueling station after the current time using a congestion prediction model trained based on variable data collected in advance and providing a user terminal with congestion prediction information for the hydrogen refueling station based on the user terminal's request for information on the hydrogen refueling station, wherein the variable data include environmental information on hydrogen refueling stations, information on the date when the environmental information was collected, and weather information of the corresponding date.

According to yet still another embodiment of the present disclosure, a computer program stored in a computer-readable recording medium may include instructions, when being executed by a processor, instructing the processor to perform requesting information on a hydrogen refueling station from a congestion prediction apparatus and providing a user with congestion prediction information for the hydrogen refueling station after the current time received from the congestion prediction apparatus, wherein the congestion prediction information is generated by a congestion prediction model trained based on variable data collected in advance, and the variable data include environmental information on hydrogen refueling stations, information on the date when the environmental information was collected, and weather information of the corresponding date.

According to still yet another embodiment of the present disclosure, a method for providing information on a refueling station for a vehicle by a user terminal may include requesting information on the refueling station from a server, receiving congestion prediction information on the refueling station after the current time from the server, and providing the congestion prediction information to the user, wherein the congestion prediction information is generated by a congestion prediction model trained based on variable data collected in advance, and the variable data include environmental information on hydrogen refueling stations, information on the date when the environmental information was collected, and weather information of the corresponding date.

According to one embodiment of the present disclosure, the number of vehicles expected to wait in line for refueling at a refueling station in the future by training a congestion prediction model using variable data related to refueling.

According to one embodiment of the present disclosure, since congestion prediction information for the future as well as real-time congestion information of refueling stations may be provided, the waiting time of a vehicle user for refueling may be effectively reduced.

According to one embodiment of the present disclosure, since vehicle users may be dispersed to refueling stations having a small number of vehicles waiting for refueling, congestion of refueling stations may be reduced.

### BRIEF DESCRIPTION OF THE DRAWINGS

FIG. 1 shows a congestion prediction system according to one embodiment of the present disclosure.

FIG. 2 shows the structure of a congestion prediction apparatus and a user terminal according to one embodiment of the present disclosure.

FIG. 3 shows congestion prediction information according to one embodiment of the present disclosure.

FIG. 4 illustrates a method for providing congestion prediction information for a hydrogen refueling station by a congestion prediction apparatus according to one embodiment of the present disclosure.

FIG. 5 illustrates a process of generating a congestion prediction model by a congestion prediction apparatus according to one embodiment of the present disclosure.

FIG. 6 illustrates a process in which a congestion prediction apparatus according to one embodiment of the present disclosure provides congestion prediction information requested by a user terminal.

FIG. 7 illustrates a method for providing congestion prediction information by a user terminal according to one embodiment of the present disclosure.

FIG. 8 illustrates a process in which a user terminal requests information for a hydrogen refueling station according to one embodiment of the present disclosure.

### DETAILED DESCRIPTION

The advantages and features of the present disclosure, and a method for achieving them will be clearly understood with reference to the embodiments described in detail together with appended drawings. However, the present disclosure is not limited to the embodiments disclosed below but may be implemented in various other forms; rather, the present embodiments are provided to make the present disclosure complete and inform those skilled in the art clearly of the technical scope of the present disclosure, and the present disclosure may be defined within the technical scope of the appended claims. Thus, in some embodiments, well-known processing steps, structures, and techniques have not been described in detail to avoid obscuring the interpretation of the present disclosure.

The terms used in the present disclosure have been selected from commonly used and widely accepted terms that best describe the functions of the present disclosure; however, it should be noted that the selection of terms may vary depending on the intention of those persons skilled in the corresponding field, precedents, or emergence of new technologies. Also, in a particular case, some terms may be selected arbitrarily by the applicant, and in this case, detailed definitions of the terms will be provided in the corresponding description of the present disclosure. Therefore, the terms used in the present disclosure should be defined not simply by their apparent name but based on their meaning and context throughout the present disclosure.

Throughout the document, unless otherwise explicitly stated, if a particular element is said to “include” some particular element, it means that the former may further include other particular elements rather than exclude them.

Also, the term “unit” or “module” used in the present disclosure may refer to a software component or a hardware component such as a Field Programmable Gate Array (FPGA) or an Application Specific Integrated Circuit (ASIC), and the “unit” or “module” performs at least one function or operation. However, the “unit” or “module” is not necessarily limited to a software or hardware component. The “unit” or “module” may be configured to be implemented in an addressable storage medium or configured to operate one or more processors. Therefore, for example, the “unit” or “module” includes those components such as software components, object-oriented software components, class components, and task components: processes, functions, properties, procedures, subroutines, segments of a program code, drivers, firmware, micro-code, circuits, data, databases, data structures, tables, arrays, and variables. The functions provided by the constituting elements and the “unit” or “module” of the present disclosure may be combined into a smaller number of constituting elements, “units”, and “modules” or further divided into additional constituting elements, “units”, or “modules”.

Also, the terms such as first, second, and third are introduced to describe various constituting elements, but the constituting elements should not be limited by the terms. The terms are used only for the purpose of distinguishing one from the other constituting elements.

In what follows, embodiments of the present disclosure will be described in detail with reference to appended drawings so that those skilled in the art to which the present disclosure belongs may readily apply the present disclosure. Moreover, to describe the present disclosure without ambiguity, those parts not related to the description of the present disclosure have been omitted. Throughout the document, the same reference symbols refer to the same constituting elements.

In what follows, a system, apparatus, and method for predicting congestion in hydrogen refueling stations among various types of vehicle refueling stations and providing congestion prediction information for a user will be described in detail. However, the present embodiments are not limited to hydrogen refueling stations and may also be applied to various types of refueling stations providing electricity, natural gas, petroleum gas, gasoline, and diesel.

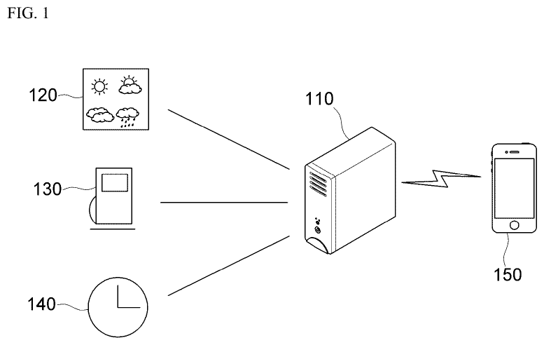

FIG. 1 shows a congestion prediction system according to one embodiment of the present disclosure.

Referring to FIG. 1, a congestion prediction system according to one embodiment of the present disclosure comprises a congestion prediction apparatus 110 and a user terminal 150.

The congestion prediction apparatus 110 generates a model for predicting the congestion of a hydrogen refueling station (or fuel refueling station) based on various variable data related to hydrogen (or fuel) refueling and generates congestion prediction information for each hydrogen refueling station (or fuel refueling station) based on the generated model. To this end, for example, the congestion prediction apparatus 110 may collect weather information 120 using an open application program interface (API) and collect environmental information 130 for each hydrogen refueling station (or fuel refueling station). Also, the congestion prediction apparatus 110 may generate a congestion prediction model by training a machine learning and/or deep learning model using environmental information 130 for each hydrogen refueling station (or fuel refueling station), date information 140 when the corresponding environmental information 130 has been collected, and weather information 120 for the corresponding hydrogen refueling station (or fuel refueling station) at the corresponding date.

The user terminal 150 may obtain or receive information on at least one hydrogen refueling station (or fuel refueling station) from the congestion predicting apparatus 110 through a wired/wireless communication network. For example, the user terminal 150 may call an API to obtain information on a hydrogen refueling station (or fuel refueling station) from the congestion prediction apparatus 110 or request information on a hydrogen refueling station (or fuel refueling station) to the congestion prediction apparatus 110 to receive the requested information. Here, the information on the hydrogen refueling station (or fuel refueling station) may include information on the location of the corresponding hydrogen refueling station (or fuel refueling station), refueling price, operating hours, operation and/or failure status, real-time congestion, and predicted congestion in the future. Also, the real-time congestion may mean the number of vehicles waiting in line at the corresponding hydrogen refueling station (or fuel refueling station) to refuel hydrogen (or fuel), and the predicted congestion in the future may indicate the predicted or expected number of vehicles waiting in line at the corresponding hydrogen refueling station (or fuel refueling station) after the current time.

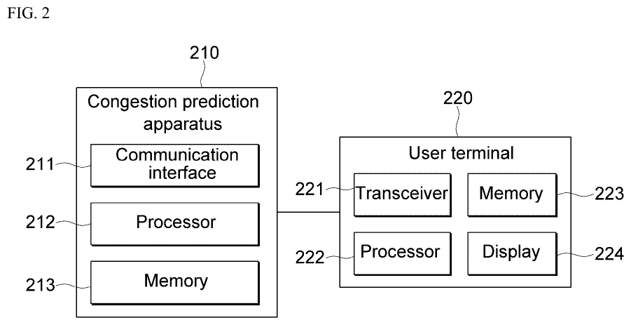

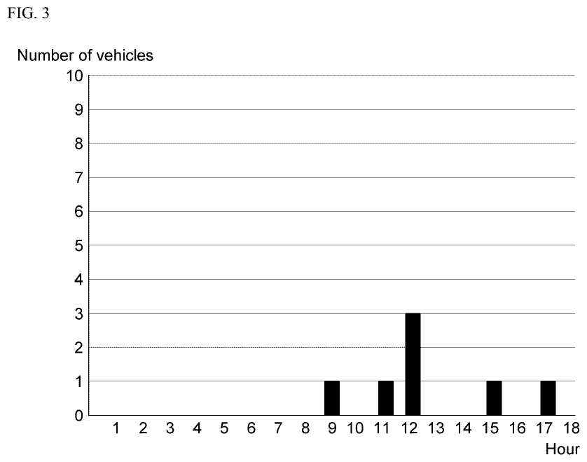

FIG. 2 shows the structure of a congestion prediction apparatus and a user terminal according to one embodiment of the present disclosure, and FIG. 3 shows congestion prediction information according to one embodiment of the present disclosure.

In what follows, the congestion prediction apparatus may be used interchangeably with various other terms, such as a congestion prediction device, a congestion prediction server, and a refueling station management server; and the user terminal may be used interchangeably with various other terms, such as a refueling station information providing apparatus and a mobile device.

Referring to FIG. 2, the congestion prediction apparatus 210 may comprise a communication interface 211, a processor 212, and a memory 213, and the user terminal 220 may comprise a transceiver 221, a processor 222, a memory 223, and a display 224.

First, referring to the congestion prediction apparatus 210, the communication interface 211 may communicate with the user terminal 220 through a wired and/or wireless network, and for this purpose, a wired communication interface and/or a wireless communication interface may be employed. For example, the communication interface 211 may receive a request for information on a hydrogen refueling station from the user terminal 220 based on the API and may provide or transmit the requested information on the hydrogen refueling station to the user terminal 220. If the user terminal 220 has mobility, the communication interface 211 may receive a request packet requesting information on at least one hydrogen refueling station from the corresponding user terminal 220 through a base station (not shown) to which the user terminal is connected and transmit information on the corresponding hydrogen refueling station to the corresponding user terminal 220. Here, the request (or request packet) may include location information of the corresponding user terminal 220 and/or an identifier of the hydrogen refueling station. Also, the request (or request packet) may include date and/or time information for congestion prediction information. The information on the hydrogen refueling station transmitted or provided by the congestion prediction apparatus 210 to the user terminal 220 may include information on the location of the hydrogen refueling station, refueling price information, operating time information, operation and/or failure status information, real-time congestion information, and congestion prediction information.

The processor 212 may generate congestion prediction information on a hydrogen refueling station after the current time using a congestion prediction model trained based on variable data collected in advance. Here, the variable data may include environmental information on hydrogen refueling stations, information on the date when the environmental information was collected, and weather information of the corresponding date. The environmental information may include at least one of an identifier of each hydrogen refueling station, the number of waiting vehicles at each hydrogen refueling station, the accumulated number of hydrogen vehicles, the accumulated number of hydrogen refueling stations, density of vehicles visiting each hydrogen refueling station per region, and inference time of the congestion prediction model, wherein the date information includes information on at least one of date, time, day of the week, weekend, and holiday, and the weather information may include information on at least one of temperature, humidity, precipitation, and precipitation type.

For example, the processor 212 may train a machine learning model and/or deep learning model using variable data (or training data) collected in advance and generate congestion prediction model for each hydrogen refueling station after the current time using the trained machine learning model and/or deep learning model, namely, the congestion prediction model. Here, the machine learning model may include a random forest regression (RFR) model, and the deep learning model may include a gate recurrent unit (GRU) model and a long short-term memory (LSTM) model.

Meanwhile, the processor 212 may pre-process training data before inputting the training data to the machine learning model and/or deep learning model. For example, the processor 212 may pre-process the training data through a process of removing outliers from the variable data (training data) based on the interquartile range for the variable data (training data) and/or the number of waiting vehicles identified by an imaging device installed at each hydrogen refueling station, a process of adding missing values to the variable data from which the outliers have been removed based on Multiple Imputation by Chained Equation (MICE), and a process of normalizing the variable data to which the missing values are added based on MinMaxScaler.

Also, the processor 212 may add a new feature to the training dataset by randomly selecting part of information (or variable) from among variable data (or training data) before inputting the training data to the machine learning model and/or deep learning model, performing arithmetic operations of the selected information (or variable), and adding the information (or variable) generated by the arithmetic operations to the variable data. Alternatively, the processor may generate categorical information (or variable) by merging information (or variables) of a specific category and add a new feature to the training dataset by adding the merged information to the variable data.

Meanwhile, the processor 212 may calculate an average refueling interval of each user based on the user's refueling history information and predict an expected refueling date of the user based on the average refueling interval. In this case, the processor 212 may determine when to transmit congestion prediction information to each user based on the expected refueling date of the user, select at least one of the hydrogen refueling stations around each user terminal 220 based on the location information of the user terminal 220 and/or an identifier of the hydrogen refueling station received from the user terminal 220, and transmit or provide the information on the selected hydrogen refueling station to the corresponding user terminal 220 at the corresponding time. Here, the information on the hydrogen refueling station may include congestion prediction information for the hydrogen refueling station, refueling price information, and the like.

The memory 213 may store the congestion prediction model generated by the processor 212, congestion prediction information for each hydrogen refueling station generated by the congestion prediction model, refueling history information of a user, location information of each hydrogen refueling station, refueling price information of each hydrogen refueling station, operating hour information of each hydrogen refueling station, operation and/or failure status information of each hydrogen refueling station, and real-time congestion information of each hydrogen refueling station.

Next, the user terminal 220 may be installed at a specific location or may be mobile. When the user terminal 220 is installed at a specific location, the user terminal 220 may communicate with the congestion prediction apparatus 210 using a wired/wireless communication interface (not shown). When the user terminal 220 is mobile, the user terminal 220 may communicate with the congestion prediction apparatus 210 through a wireless communication network using the transceiver 221. In what follows, the user terminal 220 will be described based on the assumption that it is mobile.

The transceiver 221 may call an API to obtain information on hydrogen refueling stations from the congestion predicting apparatus 210 or transmit a request packet requesting information on at least one hydrogen refueling station to the congestion prediction apparatus 210 and receive a response packet including information on the hydrogen refueling station from the congestion prediction apparatus 210. Here, the request packet may include location information of the user terminal 220 and/or an identifier of a hydrogen refueling station. Also, the request packet may include date and/or time information for congestion prediction information.

The information on the hydrogen refueling station received or obtained from the congestion prediction apparatus 210 may include location information of the corresponding hydrogen refueling station, refueling price information, operating hour information, operation and/or failure status information, real-time congestion information, and congestion prediction information. Here, the congestion prediction information may be generated by a congestion prediction model trained based on variable data collected in advance, and the variable data may include environmental information on hydrogen refueling stations, date information when the environmental information was collected, and weather information of the corresponding date.

The processor 222 may generate information related to hydrogen refueling stations based on the information received from the congestion prediction apparatus 210. For example, as shown in FIG. 3, based on the congestion prediction information for a hydrogen refueling station received from the congestion prediction apparatus 210, the processor 222 may generate prediction information for the expected number of vehicles waiting in line at the corresponding hydrogen refueling station (information on the number of vehicles expected to wait in line at the corresponding hydrogen station in the future), which may be organized by date, by hour, and/or by minute. As shown in FIG. 3, the user may visit a hydrogen refueling station with low congestion or visit a hydrogen refueling station on a date and time when congestion is low, based on the visualized congestion prediction information.

Meanwhile, the processor 222 may calculate an average refueling interval of each user based on the user's refueling history information and predict an expected refueling date of the user based on the average refueling interval. Also, the processor 222 may select at least one of hydrogen refueling stations in the surroundings of the user terminal 220 using the location information of the user terminal 220 and request information on the selected hydrogen refueling station from the congestion prediction apparatus 210. In this case, the congestion prediction apparatus may transmit or provide congestion prediction information and refueling price information for the corresponding hydrogen refueling station after the expected refueling date.

The memory 223 may store the location information of a hydrogen refueling station, refueling price information, operating hour information, operation and/or failure status information, real-time congestion information, and congestion prediction information received or obtained from the congestion prediction apparatus 210. Also, the memory 223 may store information related to hydrogen refueling stations organized by the processor 222 and refueling history information of the user.

The display 224 may display information related to hydrogen refueling stations organized or visualized by the processor 222.

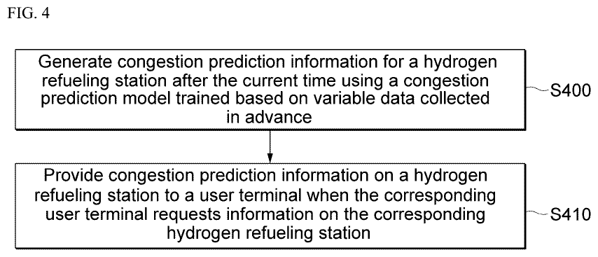

FIG. 4 illustrates a method for providing congestion prediction information for a hydrogen refueling station by a congestion prediction apparatus according to one embodiment of the present disclosure.

Referring to FIG. 4, the congestion prediction apparatus may generate congestion prediction information for a hydrogen refueling station after the current time using a congestion prediction model trained based on variable data collected in advance S400.

For example, the congestion prediction apparatus may collect variable data (training data) related to hydrogen refueling, such as the environmental information for hydrogen refueling stations, information on the date on which the environmental information has been collected, and weather information of the corresponding date, and generate a congestion prediction model by inputting the collected variable data to a pre-configured machine learning model and/or deep learning model. Here, the congestion prediction apparatus may pre-process the training data through a process of removing outliers from the collected variable data before inputting the collected variable data to the machine learning model and/or deep learning model, adding missing values to the variable data from which the outliers have been removed, and normalizing the variable data with the added missing values. Also, the congestion prediction apparatus may perform arithmetic operations on the information randomly selected from among the pre-processed variable data and add the information generated by the arithmetic operations to the pre-processed variable data.

The trained model (congestion prediction model) may output congestion prediction information based on input data. The congestion prediction information may indicate the number of vehicles waiting in a specific hydrogen refueling station at a specific time or during a specific period. The information on the number of waiting vehicles may be denoted by a label of the congestion prediction model and may be excluded from input data when data is input to the congestion prediction model to predict the future congestion of the hydrogen refueling station.

When information on at least one hydrogen refueling station is requested from the user terminal, the congestion prediction apparatus may provide congestion prediction information on the corresponding hydrogen refueling station to the corresponding user terminal using the congestion prediction model S410.

The congestion prediction apparatus may periodically update the congestion prediction model or update the congestion prediction model based on the number of times the information on the hydrogen refueling stations has been provided to the user terminal. For example, when the number of times the information on the hydrogen refueling stations is provided to the user terminal exceeds a threshold, the congestion prediction apparatus may additionally input the corresponding information to the congestion prediction model so that the congestion prediction model may output or generate a prediction result that reflects the corresponding information.

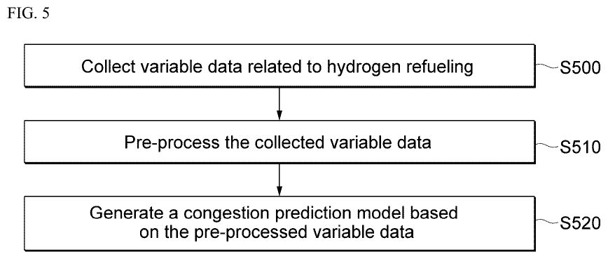

FIG. 5 illustrates a process of generating a congestion prediction model by a congestion prediction apparatus according to one embodiment of the present disclosure.

Referring to FIG. 5, the congestion prediction apparatus may collect variable data related to hydrogen refueling to predict congestion of hydrogen refueling stations S500. For example, the variable data may include information or variables as shown in Table 1.

TABLE 1

| | Variable name | Definition | Value | Unit |
|---|---|---|---|---|
| Environmental | station_name | Hydrogen | Int64 | N/A |
| variables of | | refueling station | | |
| refueling | | DB ID | | |
| station | Time | Inference time | Object | N/A |
| | total_car_num | The number of | Int64 | N/A |
| | | vehicles | | |
| | | recognized by | | |
| | | CCTV | | |
| | Car | The accumulated | Int64 | N/A |
| | | number of | | |
| | | hydrogen- | | |
| | | powered vehicles | | |
| | Station | The accumulated | Int64 | N/A |
| | | number of | | |
| | | refueling stations | | |
| | | installed | | |
| | Local car/Station | Density of | Float64 | N/A |
| | | vehicles visiting | | |
| | | each refueling | | |
| | | station per region | | |
| Weather | Temperature | Temperature | Float64 | |
| variables | Humid | Humidity | Float64 | |
| | Precipitation | Precipitation for | Float64 | mm |
| | | one hour | | |
| | precipitation_type | Precipitation type | Float64(0) | N/A |
| | | | Float64(1) | Rain |
| | | | Float64(2) | Rain/snow (sleet) |
| | | | Float64(3) | Shower |
| | | | Float64(4) | Shower |
| | | | Float64(5) | Raindrop |
| | | | Float64(6) | Raindrop/blowing snow |
| | | | Float64(7) | Blowing snow |
| Date | Year | Year | Int64 | |
| variables | Month | Month | Int64 | |
| | Day | Day | Int64 | |
| | Hour | Hour | Int64 | |
| | Minute | Minute | Int64 | |
| | Second | Second | Int64 | |
| | Weekend | Weekend | Boolean | N/A |
| | | | (true/false) | |
| | day_week | Day of the week | Object (mon, | N/A |
| | | | tue, wen, | |
| | | | thu, fri, sat, | |
| | | | sun) | |
| | Holiday | Holiday | Boolean | N/A |
| | | | (true/false) | |

Referring to Table 1, variable data includes independent variables, such as the environmental variables for hydrogen refueling stations, weather variables and date variables collecting information on the number of vehicles waiting in a hydrogen refueling station. The date variables may include information on the day of the week, weekend, and holiday, as well as subdivided variables such as year, month, day, hour, minute, and second. Also, as a dependent variable (label data), variable data may include information on the number of waiting vehicles recognized by a Closed-Circuit Television (CCTV) of a hydrogen refueling station. The congestion prediction apparatus may additionally collect and use various variables (information) usable for predicting congestion of hydrogen refueling stations in addition to the variables in Table 1.

The congestion prediction apparatus may pre-process the variable data collected as shown in Table 1 before inputting the collected variable data to the machine learning model and/or deep learning model S510. Specifically, the congestion prediction apparatus may determine and remove outliers from variable data through an outlier rejection processing. Next, the congestion prediction apparatus may apply a missing value interpolation technique showing the best performance among various missing value interpolation techniques for variable data with missing values. The congestion prediction apparatus may perform normalization on the variable data for which outlier removal and interpolation (or addition) of missing values have been applied.

For example, the congestion prediction apparatus may use an interquartile range (IQR) for information on the number of waiting vehicles, which is label data among variable data, and determine observations exceeding 1.5 times the interquartile range as outliers, where a value exceeding the maximum value may be determined as an outlier based on domain knowledge. The information on the number of waiting vehicles in a hydrogen refueling station may be collected through a CCTV installed at the hydrogen refueling station, and the maximum number of waiting vehicles that may be checked is limited by the angle of view of the camera. Therefore, in the case of information on the number of waiting vehicles, a value exceeding the maximum number of waiting vehicles allowed for the CCTV or a negative value may be determined as an outlier. Also, in the case of weather variables, the congestion prediction apparatus may remove special characters from temperature, humidity, precipitation, and precipitation type variables collected through open API and may remove outliers found using the IQR.

On the other hand, among variable data with outliers removed, to supplement the variable data with missing values, the congestion prediction apparatus may use at least one of an interpolation method using the data immediately preceding the missing value, an interpolation method using the median of the values before and after the missing value, an interpolation method using the average of the variable, and a model-based missing value interpolation method, such as the K-Nearest Neighbor (K-NN) interpolation method and the MICE method.

In the case of model-based interpolation, other variables without a missing value are also used for learning to interpolate missing values. The K-NN interpolation method performs data interpolation by training a model using N nearest neighbors to a missing value. The MICE interpolation method first constructs a first dataset by filling in missing values of all variables using average values. Next, one of the variables with missing values are restored to its original dataset with missing values, and interpolation of the corresponding variable is carried out using the other variables with filled-in missing values as independent variables. The above process is performed one after another until all variables with missing values are interpolated, after which a second dataset is constructed. The difference between the first dataset obtained by the average interpolation method and the second dataset generated by the regression method is calculated, and the above process iterates until the difference converges to 0.

To determine the missing value interpolation technique most appropriate for a congestion prediction model, the congestion prediction apparatus may evaluate the performance of an interpolation technique in question by applying random forest regression (RFR) and gate recurrent unit (GRU) models to the interpolated data. Here, the RFR and GRU models may be a basic model for which optimization has not been applied, and the mean squared error (MSE) may be used as a performance measure.

Afterward, the congestion prediction apparatus may normalize the variable data using the MinMaxScaler appropriate for a regression model. It is so because prediction of the number of vehicles waiting in a hydrogen refueling station in a near future may be modeled by a regression problem. Through data normalization, values of the independent variables may be converted to a value ranging from 0 to 1.

The congestion prediction apparatus may generate a congestion prediction model based on the variable data pre-processed through the process above S520. For example, the congestion prediction apparatus may generate a congestion prediction model by training a random forest regression model, long short-term memory, and/or gate recurrent unit model.

The congestion prediction apparatus may additionally generate a new feature variable to improve performance and extract features using backward estimation to check the influence of the variable on the model training. The backward estimation is one of the techniques used to find the best combination of variables in the presence of multiple variables, which sequentially compares performance measures while removing less important variables one by one from among all variables.

For example, the congestion prediction apparatus may convert a variable to the integer type when the datatype of the variable is string and perform one-hot encoding on the categorical data (e.g., precipitation type and holiday). Also, for example, as shown in Table 2, the congestion prediction apparatus may perform arithmetic operations by randomly selecting three variables to generate a new feature and add the generated feature to a training dataset.

TABLE 2

| Features | Calculation formula |
|---|---|
| new1 | temperature * month − hour |
| new2 | month/temperature + pre |
| new3 | hour − preci + temperature |
| new4 | precipitation + humid − month |
| new5 | humid + day * weekday |
| new6 | day/temperature * weekday |
| new7 | weekday + year + temperature |
| new8 | weekend − holiday/humid |
| new9 | fri * holiday + clear |
| new10 | holiday + sat + rain |

Meanwhile, the congestion prediction apparatus may construct a final training dataset by improving the imbalance of a label data set. The imbalance of label data is considered to be severe as the imbalanced ratio of classes increases. The imbalance ratio refers to a value obtained by dividing the number of samples belonging to the majority class by the number of samples belonging to the minority class. For example, the congestion prediction apparatus may improve data imbalance using the synthetic minority over-sampling technique (SMOTE) and/or generative adversarial network (GAN). SMOTE, one of the representative oversampling techniques, newly generates data of a class existing in a low ratio using the k-NN algorithm. GAN is also one of the oversampling techniques and is an unsupervised learning method that performs optimization in which two neural networks (generator and discriminator) contest with each other unlike existing deep learning techniques. The purpose of learning is to train the generator to create new fake data with the same probability distribution as actual data, and fake data close to actual data are obtained as a final learning result.

RFR is an ensemble algorithm that trains a multitude of decision tree models and averages the training results for prediction. The RFR model may be used for both classification and regression, efficiently prevent overfitting, and provides high prediction accuracy even when the ratio of missing values becomes large. Also, the RFR model is conveniently used for determining the importance of variables of a trained model. The congestion prediction apparatus may adjust hyper-parameters through grid search for performance optimization of the RFR model.

Meanwhile, the congestion prediction apparatus may additionally generate independent variables based on temporal data for training of the recurrent neural network (RNN) model and perform one-hot encoding on the categorical data. For example, the congestion prediction apparatus may generate ‘Season’ variable based on spring (March to May), summer (June to August), fall (September to November), and winter (December to February) with respect to ‘month’ variable and generate ‘Hour_group’ variable by defining a total of six time zones (e.g., night and dawn) from 24 hours with respect to ‘hour’ variable to extract additional features for dependent variables. The congestion prediction apparatus may perform one-hot encoding on the existing categorical variable ‘Day_week’, including ‘Season’ and “Hour_group”, and convert ‘Holiday’ and ‘Weekend into integer data. For example, ‘Holiday” and ‘Weekend’ may be Boolean variables.

RNN is suitable for a small amount of data because it iterates computing operations in the hidden layer using the weights of the previous operation result; however, as the model calculation process iterates, the weights gradually converge to 0, leading to vanishing of significance of the past data. LSTM, which belongs to the RNN family, was developed to compensate for the gradient vanishing effect in the RNN. LSTM is composed of multiple gates (forget gate, input gate, and output gate) and selectively decides whether to use the information learned from the previous layer for the calculation in the subsequent layer.

Meanwhile, the GRU is built on a simplified LSTM structure, characterized with similar performance but fast processing speed. While the LSTM employs three gates, the GRU is composed of two gates (rest gate and update gate). The GRU decides whether to reflect the information from the previous layer, performs computing operations, and passes information quickly to the next layer. The GRU provides an advantage over the LSTM in terms of processing speed by requiring fewer computations, but the difference in performance between the two models is not substantial.

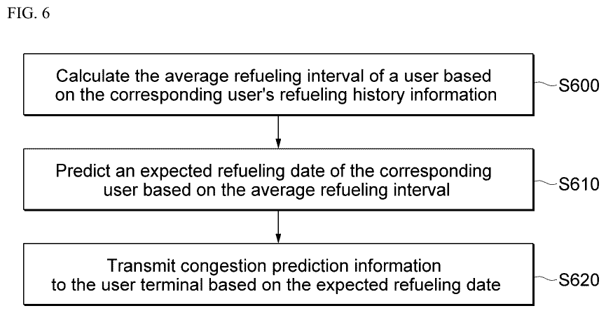

FIG. 6 illustrates a process in which a congestion prediction apparatus according to one embodiment of the present disclosure provides congestion prediction information requested by a user terminal.

Referring to FIG. 6, the congestion prediction apparatus may calculate the average refueling interval of a user based on the corresponding user's refueling history information S600 and predict an expected refueling date of the corresponding user based on the average refueling interval S610. The congestion prediction apparatus may determine when to transmit the congestion prediction information to the corresponding user terminal based on the expected refueling date.

For example, the congestion prediction apparatus may derive a refueling interval by calculating the difference between the first refueling date and the second refueling date based on the refueling history information of the corresponding user and calculate the average refueling interval by calculating an average value of the refueling interval. Also, the congestion prediction apparatus may derive an expected refueling date of the corresponding user by adding the last refueling date of the corresponding user and the average refueling interval. Afterward, when the current date approaches the expected refueling date, the congestion prediction apparatus may select at least one of the hydrogen refueling stations around the corresponding user terminal based on the location information of the corresponding user (or user terminal) and transmit or provide information on the selected hydrogen refueling station to the corresponding user terminal S620. Alternatively, the congestion prediction apparatus may request an identifier of a hydrogen refueling station near the corresponding user from the corresponding user terminal and transmit or provide information on the hydrogen refueling station corresponding to the identifier received from the corresponding user terminal to the corresponding user terminal.

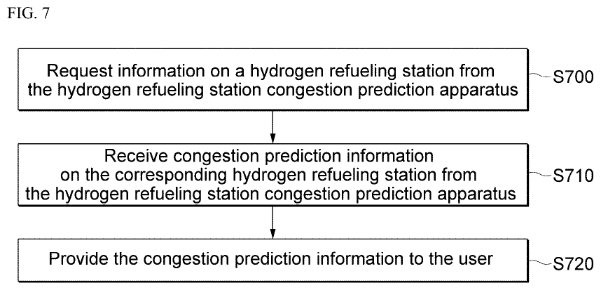

FIG. 7 illustrates a method for providing congestion prediction information by a user terminal according to one embodiment of the present disclosure.

Referring to FIG. 7, the user terminal may request information on a hydrogen refueling station from the congestion prediction apparatus S700 and receive congestion prediction information on the corresponding hydrogen refueling station from the congestion prediction apparatus S710. For example, the user terminal may call an API to obtain information on hydrogen refueling stations from the congestion predicting apparatus or transmit a request packet requesting information on at least one hydrogen refueling station to the congestion prediction apparatus and receive a response packet responding to the request packet. Here, the request packet may include location information of the user terminal and/or an identifier of a hydrogen refueling station. Also, the request packet may include date and/or time information for congestion prediction information.

The information on the hydrogen refueling station received from the congestion prediction apparatus by the user terminal may include location information of the corresponding hydrogen refueling station, refueling price information, operating hour information, operation and/or failure status information, real-time congestion information, and congestion prediction information. Here, the congestion prediction information may be generated by a congestion prediction model trained based on variable data collected in advance, and the variable data may include environmental information on hydrogen refueling stations, date information when the environmental information was collected, and weather information of the corresponding date.

The user terminal may provide congestion prediction information received from the congestion prediction apparatus to the user S720. For example, the user terminal may generate information related to hydrogen refueling stations based on the information received from the congestion prediction apparatus. Also, the user terminal may provide prediction information for the expected number of vehicles waiting in line at the corresponding hydrogen refueling station, organized by date, by week, by hour, and/or by minute. As shown in FIG. 3, the user may visit a hydrogen refueling station with low congestion or visit a hydrogen refueling station on a date and time when congestion is low, based on the visualized congestion prediction information.

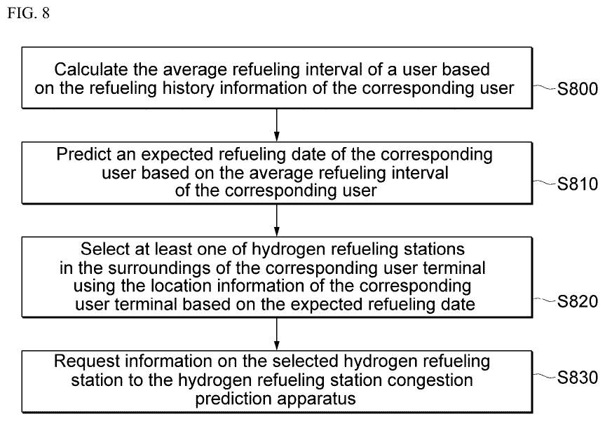

FIG. 8 illustrates a process in which a user terminal requests information for a hydrogen refueling station according to one embodiment of the present disclosure.

Referring to FIG. 8, the user terminal may calculate the average refueling interval of a user based on the refueling history information of the corresponding user S800 and predict an expected refueling date of the corresponding user based on the average refueling interval S810. For example, the user terminal may derive a refueling interval by calculating the difference between the first refueling date and the second refueling date based on the refueling history information of the corresponding user received from the congestion prediction apparatus and derive the average refueling interval by calculating the average value of the refueling interval. Also, the user terminal may derive an expected refueling date of the corresponding user by adding the last refueling date of the corresponding user and the average refueling interval.

The user terminal may select at least one of hydrogen refueling stations in the surroundings of the corresponding user terminal using the location information of the corresponding user terminal based on the expected refueling date S820 and request information on the selected hydrogen refueling station to the congestion prediction apparatus for hydrogen refueling stations S830. For example, if the current date approaches the expected refueling date of the user, the user terminal may transmit the Global Positioning System (GPS) information of the user terminal to the congestion prediction apparatus for hydrogen refueling stations or transmit an identifier of at least one hydrogen refueling station selected from among hydrogen refueling stations in the surroundings of the corresponding user terminal based on the GPS information of the user terminal to the congestion prediction apparatus for hydrogen refueling stations. In this case, the congestion prediction apparatus for hydrogen refueling stations may transmit or provide information on the corresponding hydrogen refueling station to the corresponding user terminal based on the GPS information of the corresponding user terminal or the identifier of the hydrogen refueling station received from the corresponding user terminal.

Meanwhile, each step included in the method for providing congestion prediction information performed by the congestion prediction apparatus and/or user terminal according to the embodiments may be implemented by a computer program including instructions instructing a processor to execute the step.

Also, each step included in the method for providing congestion prediction information performed by the congestion prediction apparatus and/or user terminal according to the embodiments may be implemented in a computer-readable recording medium storing a computer program including instructions instructing a processor to execute the step.

Combinations of individual steps of the appended flow diagrams of the present disclosure may be performed by computer program instructions. Since these computer program instructions may be provided to a processor of a general-purpose computer, a special-purpose computer, or other programmable data processing apparatus, the instructions executed through the processor of the computer or other programmable data processing apparatus generate means for implementing the functions specified in the individual steps of the flow diagrams. Since these computer program instructions may also be stored in a computer-usable or computer-readable memory that may be directed to a computer or other programmable data processing apparatus to implement a function in a particular manner, the instructions stored in the computer-usable or computer-readable memory may produce a manufacturing item including instructions that execute the functions specified in the individual steps of the flow diagrams. Since the computer program instructions may also be loaded onto a computer or other programmable data processing apparatus, by performing a series of operational steps on the computer or other programmable data processing apparatus to generate a process executed by the computer, the instructions operating the computer or other programmable data processing apparatus may also provide steps for executing the functions specified in the respective steps of the flow diagrams.

Also, each step may represent part of a module, segment, or code including one or more executable instructions for executing a specific logical function(s). Also, it is also possible that in some alternative embodiments, the specified functions are executed out of specified order. For example, it is possible that two steps shown one after another may be performed simultaneously, or the steps may be performed in reverse order depending on the corresponding functions.

The above description is merely exemplary description of the technical scope of the present disclosure, and it should be understood by those skilled in the art that various changes and modifications may be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims, and it should be appreciated that all technical scopes included within a range equivalent thereto are included in the protection scope of the present disclosure.

### DETAILED DESCRIPTION OF MAIN ELEMENTS

110: Congestion prediction apparatus
120: Weather information
130: Environmental information for refueling station
140: Date information
150: User terminal

What is claimed is:

1. A method for providing information on a hydrogen refueling station by a user terminal, the method comprising:
requesting information on the hydrogen refueling station from a congestion prediction apparatus;
receiving congestion prediction information for the hydrogen refueling station after the current time from the congestion prediction apparatus; and
providing the congestion prediction information to a user,
wherein the congestion prediction information is generated by a congestion prediction model trained based on variable data collected in advance, and
the variable data include environmental information on hydrogen refueling stations, information on the date when the environmental information was collected, and weather information of the corresponding date.

2. The method of claim 1, wherein the congestion prediction information includes information on the number of waiting vehicles at the hydrogen refueling station predicted for each unit time.

3. The method of claim 1, wherein the environmental information includes at least one of an identifier of each hydrogen refueling station, the number of waiting vehicles in each hydrogen refueling station, the accumulated number of hydrogen vehicles, the accumulated number of hydrogen refueling stations, density of vehicles visiting each hydrogen refueling station per region, and inference time of the congestion prediction model,
wherein the date information includes information on at least one of date, time, day of the week, weekend, and holiday, and
the weather information includes information on at least one of temperature, humidity, precipitation, and precipitation type.

4. The method of claim 1, wherein the variable data further includes information generated by arithmetic operations on the information randomly selected from among the variable data.

5. The method of claim 1, wherein the variable data is pre-processed before being input to the congestion prediction model, and
the pre-processing includes:
a process of removing outliers from the variable data based on at least one of the interquartile range for the variable data and the number of waiting vehicles identified by an imaging device installed at each hydrogen refueling station,
a process of adding missing values to the variable data from which the outliers have been removed based on Multiple Imputation by Chained Equation (MICE), and a process of normalizing the variable data to which the missing values are added based on MinMaxScaler.

6. The method of claim 1, further comprising:
calculating an average refueling interval of the user based on the user's refueling history information and
predicting an expected refueling date of the user based on the average refueling interval.

7. The method of claim 6, wherein the requesting includes:
selecting at least one of hydrogen refueling stations in the surroundings of the user from the user's location information and
requesting information on the selected hydrogen refueling station from the congestion prediction apparatus,
wherein the information on the selected hydrogen refueling station includes congestion prediction information and refueling price information for the corresponding hydrogen refueling station after the expected refueling date.

8. A method for providing congestion prediction information for a hydrogen refueling station by a congestion prediction apparatus, the method comprising:
generating congestion prediction information for the hydrogen refueling station after the current time using a congestion prediction model trained based on variable data collected in advance; and
providing a user terminal with congestion prediction information for the hydrogen refueling station based on the user terminal's request for information on the hydrogen refueling station,
wherein the variable data include environmental information on hydrogen refueling stations, information on the date when the environmental information was collected, and weather information of the corresponding date.

9. The method of claim 8, wherein the congestion prediction information includes information on the number of waiting vehicles at the hydrogen refueling station predicted for each unit time.

10. The method of claim 8, wherein the environmental information includes at least one of an identifier of each hydrogen refueling station, the number of waiting vehicles in each hydrogen refueling station, the accumulated number of hydrogen vehicles, the accumulated number of hydrogen refueling stations, density of vehicles visiting each hydrogen refueling station per region, and inference time of the congestion prediction model,
wherein the date information includes information on at least one of date, time, day of the week, weekend, and holiday, and
the weather information includes information on at least one of temperature, humidity, precipitation, and precipitation type.

11. The method of claim 8, further comprising before the generating:
performing arithmetic operations on the information randomly selected from among the variable data; and
adding the information generated by the arithmetic operations to the variable data.

12. The method of claim 8, further comprising before the generating:
removing outliers from the variable data based on at least one of the interquartile range for the variable data and the number of waiting vehicles identified by an imaging device installed at each hydrogen refueling station,
adding missing values to the variable data from which the outliers have been removed based on Multiple Imputation by Chained Equation (MICE), and
normalizing the variable data to which the missing values are added based on MinMaxScaler.

13. The method of claim 8, further comprising before the generating:
calculating an average refueling interval of the user based on the user's refueling history information;
predicting an expected refueling date of the user based on the average refueling interval; and
determining when to transmit the congestion prediction information to the user terminal based on the expected refueling date.

14. The method of claim 8, further comprising before the generating:
generating information on at least one of hydrogen refueling stations in the surroundings of the user terminal based on at least one of location information of the user terminal and the identifier of a hydrogen refueling station received from the user terminal,
wherein the information on at least one of hydrogen refueling stations in the surroundings of the user terminal includes congestion prediction information and refueling price information for the corresponding hydrogen refueling station.

15. A method for providing information on a refueling station for a vehicle by a user terminal, the method comprising:
requesting information on the refueling station from a server;
receiving congestion prediction information on the refueling station after the current time from the server; and
providing the congestion prediction information to the user,
wherein the congestion prediction information is generated by a congestion prediction model trained based on variable data collected in advance, and
the variable data include environmental information on hydrogen refueling stations, information on the date when the environmental information was collected, and weather information of the corresponding date.

16. The method of claim 15, wherein the congestion prediction information includes information on the number of waiting vehicles at the hydrogen refueling station predicted for each unit time.

17. The method of claim 15, wherein the environmental information includes at least one of an identifier of each hydrogen refueling station, the number of waiting vehicles in each hydrogen refueling station, the accumulated number of hydrogen vehicles, the accumulated number of hydrogen refueling stations, density of vehicles visiting each hydrogen refueling station per region, and inference time of the congestion prediction model,
wherein the date information includes information on at least one of date, time, day of the week, weekend, and holiday, and
the weather information includes information on at least one of temperature, humidity, precipitation, and precipitation type.

18. The method of claim 15, wherein the variable data further includes information generated by arithmetic operations on the information randomly selected from among the variable data.

19. The method of claim 15, wherein the variable data is pre-processed before being input to the congestion prediction model, and
the pre-processing includes:
a process of removing outliers from the variable data based on at least one of the interquartile range for the variable data and the number of waiting vehicles identified by an imaging device installed at each hydrogen refueling station,
a process of adding missing values to the variable data from which the outliers have been removed based on Multiple Imputation by Chained Equation (MICE), and
a process of normalizing the variable data to which the missing values are added based on MinMaxScaler.

20. The method of claim 15, further comprising before the requesting:
calculating an average refueling interval of the user based on the user's refueling history information; and
predicting an expected refueling date of the user based on the average refueling interval; and
the requesting includes:
selecting at least one of hydrogen refueling stations in the surroundings of the user from the user's location information; and
requesting information on the selected hydrogen refueling station from the congestion prediction apparatus,
wherein the information on the selected hydrogen refueling station includes congestion prediction information and refueling price information for the corresponding hydrogen refueling station after the expected refueling date.
